(19) United States
(12) Patent Application Publication
(10) Pub. No.: US 2011/0103193 A1
(43) Pub. Date: May 5, 2011

(54) Personal Alert System with Adhesive Fixation

(76) Inventors: Denis Jimenez, Marshall, TX (US); Christine Jimenez, Marshall, TX (US)

(21) Appl. No.: 12/610,995

(22) Filed: Nov. 2, 2009

(51) Int. Cl. G04C 21/00

(52) U.S. Cl. 368/73

(57) ABSTRACT

The present disclosure generally provides systems and methods of alerting a user at a predetermined time. This may be accomplished with a personal alarm device according to an embodiment of the present disclosure. Such personal alarm device includes an alarm clock that is coupled to an adhesive material. The adhesive material is adapted to allow the alarm clock to be affixed to the skin of the user. The adhesive material also allows the user to remove the personal alarm device from the skin of the user. The alarm clock is a self-contained unit that is operable to display a time, allow the user to set a predetermined time, and alert the user at the predetermined time. The self-contained unit may perform all of these functions without communicating with an external device, but may also function in connection with an external device or system.

### TECHNICAL FIELD

The present disclosure generally relates to alarm clocks, and more particularly to personal alert systems that adhere to the skin of the user.

### BACKGROUND

Personal clocks are common in the art. Some include an alarm feature and others do not. Examples of personal clocks not including an alarm feature include U.S. Pat. Nos. 7,324,410 (“Ziv”); 3,998,045 (“Lester”); and 4,444,515 (“Clark”). Clocks including an alarm feature include 6,817,192 (“Ector, Jr.”) and U.S. patent application Ser. No. 12/039,972 (Pub. No. U.S. 2009/0052283 A1) (“Puzia”). However, none of these references appear to disclose a personal alarm clock that adheres to the skin of the user.

Other examples of personal alarm clocks are inserted in or cover the ear of user. Examples of these devices include U.S. Pat. Nos. 4,821,247 (“Grooms”); 6,067,006 (“O'Brien”); 7,571,006 (“Gordon”); and 7,512,247 (“Odinak”). Still other personal alarm clocks communicate with an external device to function. Examples of these devices include U.S. Pat. Nos. 5,686,882 (“Giani”); 7,173,881 (“Freudenberg, Jr.”); 7,266,047 (“Chan”); and U.S. patent application Ser. No. 11/030,047 (Pub. No. U.S. 2006/0153007 A1) (“Chester”). U.S. Pat. No. 5,894,455 (“Sikes”) is an example of a personal alarm system that is inserted in the ear and communicates with an external device to function.

Thus, there exists a need for a personal alarm clock that is a single unit that does not require communication with an external device and that adheres to the skin of a user in a location such that an audible alarm will only alert the user and not others in close proximity. A need also exists for a personal alarm clock that operates while not being inserted into, attached to, or covering the ear.

### SUMMARY

Embodiments of the present disclosure generally provide systems and methods of alerting a user at a predetermined time. This may be accomplished with a personal alarm device according to an embodiment of the present disclosure. Such personal alarm device includes an alarm clock that is coupled to an adhesive material. The adhesive material is adapted to allow the alarm clock to be affixed to the skin of the user. The adhesive material also allows the user to remove the personal alarm device from the skin of the user. The alarm clock is a self-contained unit that is operable to display a time, allow the user to set a predetermined time, and alert the user at the predetermined time. The self-contained unit may perform all of these functions without communicating with an external device, but may also function in connection with an external device or system.

In one embodiment, the present disclosure could allow a user to affix the personal alarm device to the skin near the ear of the user, thus allowing an audible or vibrating alarm to only alert the user without disturbing others in close proximity. This may be particularly beneficial if two people sleeping in the same bed need to wake up at different times.

In one embodiment, the present disclosure could allow a user to be awoken by an alarm clock that is located in close proximity to his or her ear, but is not inserted in or does not cover the ear. Thus, using the device in accordance with the teachings of the present disclosure will continue to allow a user to comfortably wear the device and continue to be able to hear a fire alarm, door bell, child crying, and the like.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 is a view of a personal alarm device affixed to a user according to one embodiment of the present disclosure;

FIG. 2A illustrates a top view of the personal alarm device of FIG. 1 according to one embodiment of the present disclosure;

FIG. 2B is illustrates a view of the back of the personal alarm device of FIG. 1 according to one embodiment of the present disclosure;

FIG. 2C illustrates a side view with portions cut away to reveal some of the inner workings of the personal alarm device of FIG. 1 according to one embodiment of the present disclosure;

FIG. 3A illustrates a top view of an alternate embodiment of a personal alarm device including a vibration mode according to one embodiment of the present disclosure;

FIG. 3B illustrates a side view with portions cut away to reveal some of the inner workings of the personal alarm device of FIG. 3A according to one embodiment of the present disclosure;

FIG. 4A illustrates a top view of the personal alarm device of FIG. 3A showing the personal alarm device secured in a carrying case according to one embodiment of the present disclosure; and

FIG. 4B illustrates a side view of the carrying case shown in FIG. 4A and a personal alarm device with portions cut away to reveal some of the inner workings of the personal alarm device according to one embodiment of the present disclosure.

### DETAILED DESCRIPTION

The present disclosure generally provides systems and methods of a personal alarm device that may be affixed directly to the skin of the user. In this fashion, an audible or vibrational signal emitting from the personal alarm clock is likely only to be detected by the user, thus leaving others in close proximity undisturbed.

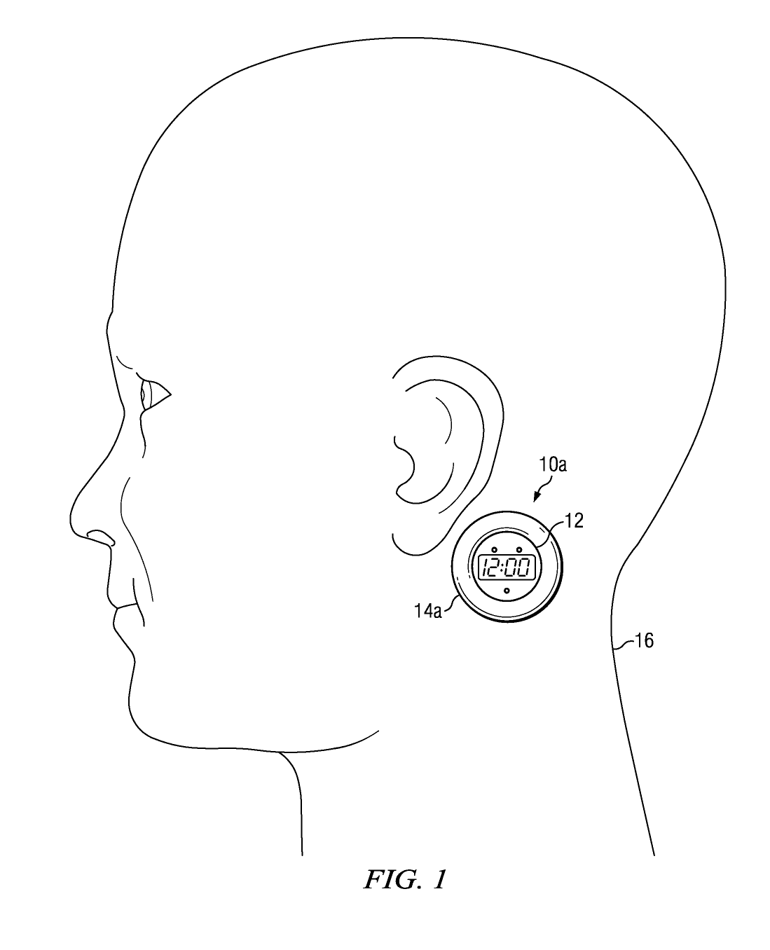

FIG. 1 shows an embodiment of a personal alarm device 10a in accordance with the teachings of the present disclosure. It should be understood that the personal alarm systems shown in FIGS. 1-4B are for illustrative purposes only and that any other suitable system or subsystem could be used in conjunction with or in lieu of the illustrated personal alarm systems according to the present disclosure.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

FIG. 1 illustrates the personal alarm device 10a shown affixed to a wearer or user 16. The personal alarm device may be sized to fit comfortably on a top portion of the neck of the user 16 adjacent the ear of the user 16. In this location, the personal alarm device 10a may audibly (or vibrationally) alert the user 16 with a soft audible sound even though there is no part of the personal alarm device that is internal to the ear of the user 16. The personal alarm device includes an alarm clock 12 and an external envelope 14a.

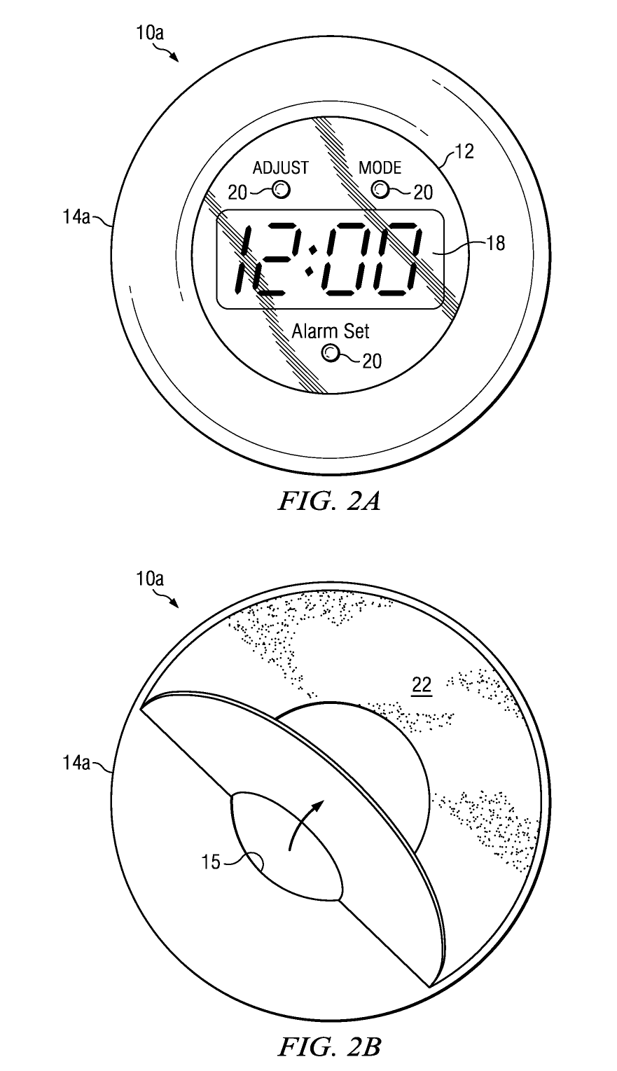

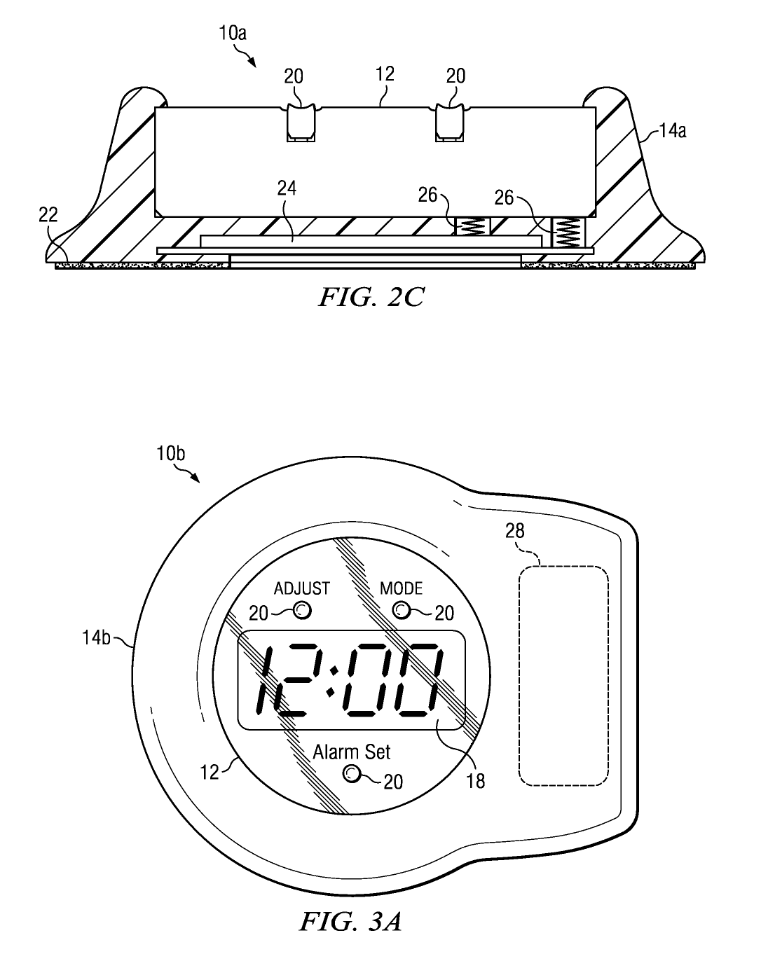

FIG. 2A illustrates a top view of the personal alarm device 10a. In certain embodiments, the alarm clock 12 of the personal alarm device 10a may be similar to a conventional digital watch. It may include a display 18 and function buttons 20. In certain embodiments, the display 18 may be a digital display. A battery that is well known in the art may provide power for the personal alarm device 10a. In an alternate embodiment, the alarm clock 12 may be replaced with a wireless receiver. In this embodiment, the receiver may receive a transmission from an emitter. According to the teachings of the present disclosure, reception of this transmission may activate an audible or vibrational alarm to alert the wearer to take a certain action.

Function buttons 20 may be small relative to the face of alarm clock 12 and may be depressed with the tip of a pen or other slender object. Using the function buttons 20, the user may set the current time and set a predetermined time that he desires to be alerted by the alarm. When the alarm is sounding or vibrating, the function buttons 20 may also allow the user 16 to initiate a sleep function or to disable the alarm altogether. In certain embodiments, the user 16 may operate the personal alarm device 10a in a countdown mode, which counts down from a predetermined time. This may allow the user to quickly set the alarm to alert him in twenty minutes if the user 16 desires to take a quick nap in a location such as a library or the like. In this mode, the alarm clock 12 counts down from twenty minutes and alerts the user when it reaches zero.

The external envelope 14a may serve several functions. For example, the external envelope 14a may define a circular opening 15 extending from its center causing the bottom surface of the external envelope 14a to be generally annular. This opening 15 may allow the audible alarm to pass more directly to the user 16. The external envelope 14a may be made of a soft material, for example silicone. This soft material of the external envelope 14a may increase the comfort for the user 16. It may also protect the alarm clock 12 from any damage that may occur if it is dropped or casually handled when carrying in a travel bag, purse, brief case, and the like. In some embodiments, the external envelope 14a may also be made of a rigid material.

FIG. 2B shows the back of personal alarm device 10a. Also, on a back surface of either the alarm clock 12 or the external envelope 14a, or both may be affixed an adhesive material 22. The adhesive material 22 may allow the personal alarm device 10a to temporarily adhere to the skin of the user 16. The adhesive material 22 may be made of a hypoallergenic material. In certain embodiments, the adhesive material 22 may have adhesive properties on a front surface and a back surface of the adhesive material 22, making it double-sided adhesive material 22. The adhesive material 22 may lose some of its adhesive properties, that is, after being attached and removed a number of times it may no longer adequately adhere to the skin of the user 16. Therefore, in certain embodiments, adhesive material 22 may be easily removed from the personal alarm device 10a, disposed of, and then replaced with a new adhesive material 22.

FIG. 2C illustrates the personal alarm device 10a in accordance with an embodiment of the present disclosure. FIG. 2C shows the personal alarm device from a side view with portions cut away so that some of the inner workings of personal alarm device are visible. From this illustration, it can also be seen that the external envelope 14a encases the alarm clock 12. It can also be seen that the personal alarm device 10a includes an audio transducer 24 connected to the alarm clock 12 by electrical connections 26. When the alarm clock 12 reaches the predetermined time it may cause the electrical connections 26 to activate the audio transducer 24. With the audio transducer activated, the personal alarm device 10a may emit an audible alarm. This audible alarm may be soft such that it is detectible by the user, but not others in close proximity. In an alternate embodiment, the audio transducer may be internal to the alarm clock 12.

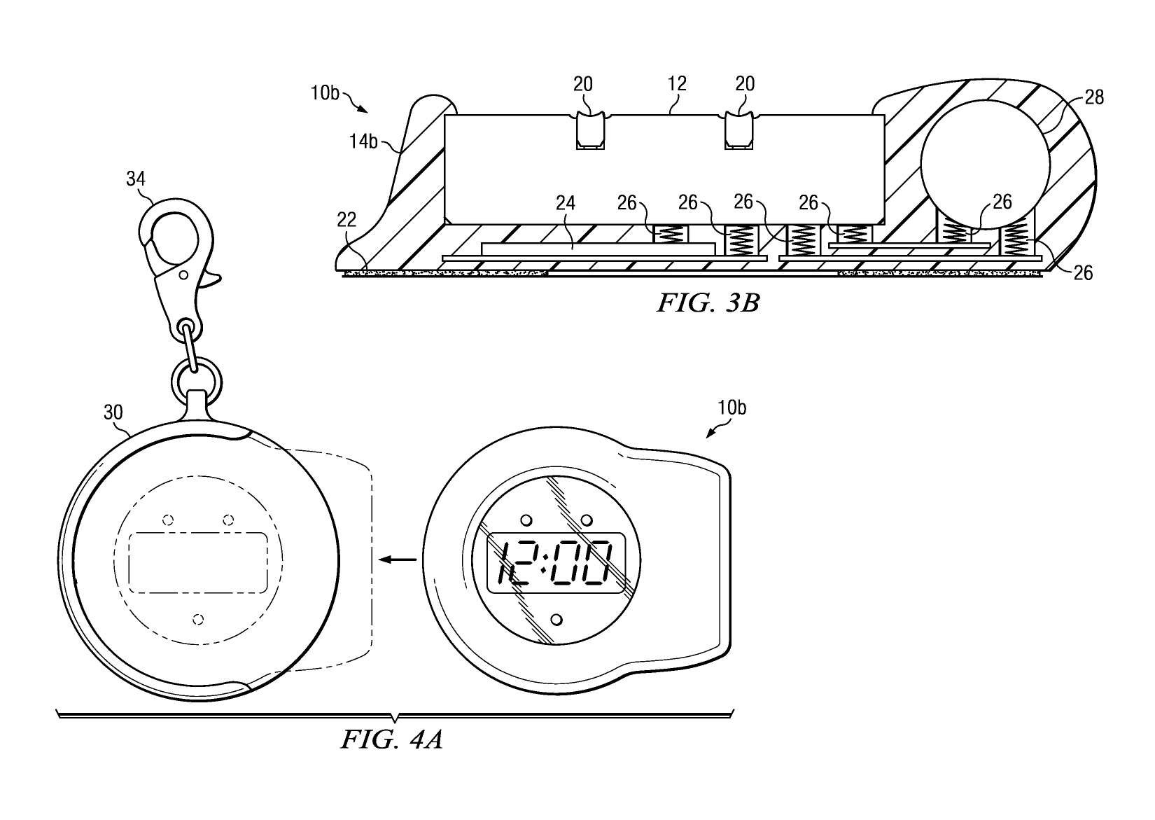

FIG. 3A illustrates an alternative embodiment of the present disclosure. FIG. 3A illustrates a personal alarm device with vibration mode 10b. This is similar in many respects to the personal alarm device 10a, except it includes a vibrating module 28. The alarm clock 12 may activate the vibrating module 28 in lieu of or in addition to the audible alarm to alert the user 16 that the predetermined time has been reached. The vibrating module 28 may be an electro-mechanical vibrator as is known in the art. In this embodiment, function buttons 20 may allow the user to control whether a vibration mode is activated. Also, in this embodiment, a vibrating model external envelope 14b is similar to the external envelope 14a, but it is shaped to enclose the vibrating module 28.

FIG. 3B illustrates the personal alarm device with vibration mode 10b in accordance with an embodiment of the present disclosure. FIG. 3B shows a side view with portions cut away so some of the inner workings are visible. It can be seen that electrical connections from the alarm clock 12 are connected to the vibrating module. The particular embodiment pictured in FIG. 3B shows the audio transducer 24 in addition to vibrating module 28. In alternative embodiments of the present disclosure, the personal alarm device with vibration mode may only include the vibrating module 28 and not the audio transducer 26. It should also be noted that the personal alarm device may be attached to a variety of places on the user, and may further include an input to adjust the level of an audible or vibrant only alarm.

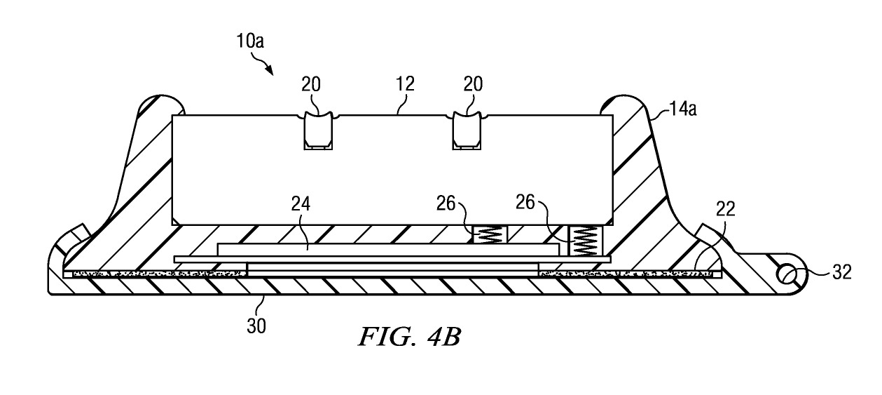

FIGS. 4A and 4B illustrate an embodiment where a personal alarm device in accordance with the present disclosure is secured in a carrying device 30. The carrying device 20 may partially enclose either personal alarm device 10a (as shown in FIG. 4B) or personal alarm device with vibration mode 10b as shown (as shown in FIG. 4A). The carrying device 30 may be made of metal or a firm plastic to allow it to flex in order to receive and secure the personal alarm device 10a or 10b. The carrying device 30 may also include a protrusion having an aperture 32 for receiving a clasp 34, as shown in FIG. 4A. The clasp 34 may allow a user to carry the personal alarm device 10a or 10b on a key chain or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A personal alarm device, comprising:
an alarm clock coupled to an adhesive material;
the adhesive material adapted to allow the alarm clock to be removably affixed to skin of a user; and
the alarm clock being a self-contained unit operable to display a time, allow the user to set a predetermined time, and alert the user at the predetermined time.

2. The personal alarm device of claim 1, further comprising an external envelope encasing the alarm clock.

3. The personal alarm device of claim 2, wherein the external envelope comprises silicone.

4. The personal alarm device of claim 2, further comprising an outer casing encasing the external envelope and the alarm clock.

5. The personal alarm device of claim 1, further comprising an audio transducer operable to audibly alert the user at the predetermined time.

6. The personal alarm device of claim 1, further comprising a vibrating module operable to vibrate at the predetermined time.

7. The personal alarm device of claim 1, further comprising:
an audio transducer operable to alert the user by emitting an audible sound at the predetermined time; and
a vibrating module operable to alert the user by vibrating at the predetermined time.

8. The personal alarm device of claim 1, wherein the adhesive material comprises a double-sided adhesive material that is disposable, hypoallergenic, and removable from the personal alarm device.

9. A personal alarm device for alerting a user without disturbing others located nearby, the personal alarm device placed on the skin near an ear of the user without being inserted or covering the ear, the personal alarm device comprising:
an alarm clock, the alarm clock having a display for displaying a time;
an adhesive material coupled to the alarm clock, the adhesive material adapted to be removably affixed to skin of a user;
an external envelope encasing the alarm clock;
programming functions contained within the personal alarm device, the programming functions allowing the user to set a predetermined time and be alerted at the predetermined time without the personal alarm device communicating with an external device; and
an audio transducer or a vibrating module operable to alert the user at the predetermined time.

10. The personal alarm device of claim 9, wherein the external envelope comprises silicone.

11. The personal alarm device of claim 9, wherein the personal alarm device is not inserted in an ear of the user and is not attached to the ear of the user.

12. The personal alarm device of claim 9, wherein the personal alarm device and does not cover the ear of the user.

13. The personal alarm device of claim 9, wherein the adhesive material comprises a double-sided adhesive material that is disposable, hypoallergenic, and removable from the personal alarm device.

14. The personal alarm device of claim 9, further comprising an outer casing encasing the external envelope and the alarm clock.

15. A method for alerting a user at a predetermined time, comprising:
programming a personal alarm device, comprising:
an alarm clock coupled to an adhesive material,
the adhesive material adapted to allow the alarm clock to be removably affixed to skin of a user, and
the alarm clock being a self-contained unit operable to display a time, allow the user to set a predetermined time, and alert the user at the predetermined time;
removably affixing the personal alarm device on the skin of the user using the adhesive material, the personal alarm device being placed near the ear of the user, but not attached to, inserted in, or covering the ear; and
alerting the user at the predetermined time with an alarm of the personal alarm device.

16. The method of claim 15, further comprising selecting a disable function by the user.

17. The method of claim 15, further comprising selecting a sleep function by the user, selection of the sleep function temporarily disables the alarm for a time interval.

18. The method of claim 15, wherein alerting the user further comprises emitting by an audio transducer in the personal alarm device an audible sound at the predetermined time.

19. The method of claim 15, wherein alerting the user further comprises activating a vibration module in the personal alarm device at the predetermined time.

20. The method of claim 15, further comprising:
removing the personal alarm device from the user after the user is alerted at the predetermined time; and
replacing the adhesive material.
